(19) United States
(12) Patent Application Publication
(10) Pub. No.: US 2011/0033251 A1
(43) Pub. Date: Feb. 10, 2011

(54) ROTARY CUTTING TOOL WITH REVERSE CHIPBREAKER PATTERN

(75) Inventor: Danny Ray Davis, Asheboro, NC (US)

Correspondence Address: KENNAMETAL INC.;Intellectual Property Department, P.O. BOX 231, 1600 TECHNOLOGY WAY, LATROBE, PA, 15650, US

(73) Assignee: KENNAMETAL INC., Latrobe, PA (US)

(21) Appl. No.: 12/535,607

(22) Filed: Aug. 4, 2009

(51) Int. Cl. B26D 7/18

(52) U.S. Cl. 407/114

(57) ABSTRACT

A rotary cutting tool with a longitudinal axis includes a shank portion, a cutting portion, and a plurality of chipbreakers. The cutting portion includes a plurality of blades and a plurality of flutes. The blades and flutes extend substantially along the length of the cutting portion. Each blade includes a leading face, a trailing face, and a land surface that extends between the leading face and the trailing face. The chipbreakers are disposed in the land surfaces of the blades. The chipbreakers on each blade are equidistant from each other and are distributed in a reverse chipbreaker pattern among the blades such that each chipbreaker on a preceding blade is closer to the cutting tip than a corresponding chipbreaker on an immediately adjacent following blade for a particular direction of rotation of the rotary cutting tool.

### FIELD OF THE INVENTION

In general, the invention relates to a rotary cutting tool, and in particular to an end mill having a reversed chipbreaker pattern such that a chipbreaker on a preceding blade is closer to the cutting tip than a corresponding chipbreaker on an immediately adjacent following blade for a particular direction of rotation of the cutting tool.

### BACKGROUND OF THE INVENTION

Rotary cutting tools, such as end mills, typically have a cylindrical configuration that includes a shank portion and a cutting portion. The cutting portion contains a plurality of helically disposed cutting blades that extend from a first end (i.e., the “shank portion”) of the cutting portion adjacent the shank portion, toward the opposite end (i.e., the “free end”) of the cutting portion. In some embodiments, the cutting edges of the helical blades are disposed along a substantially constant radius with respect to the longitudinal axis of the tool. In other embodiments, generally referred to as “tapered” cutting tools, the cutting portion is substantially frustoconical in shape; i.e., the cutting edge of each blade has a constantly decreasing radius with respect to the longitudinal axis of the tool as the cutting edge extends from the shank portion of the cutting portion to the free end. The cutting edges of the blades in a tapered rotary cutting tool are at the same radius from the longitudinal axis of the tool in any plane through the cutting portion and perpendicular to the longitudinal axis of the tool. In still other end mill embodiments, generally referred to as “straight-fluted” rotary cutting tools, the cutting edges of the blades extend parallel to the longitudinal axis of the tool.

There are several inherent problems in the use of any of the conventional rotary cutting tools described above. Generally, these problems manifest themselves in excessive wear and relatively poor cutting actions, or both, due to the fact that the entire length of the cutting edge may be applied to the workpiece at the same time, and due to the fact that continuous chips are produced which are not adequately removed from the work area. There have been many attempts to improve the cutting action and decrease the wear in such tools, and these attempts usually involve the use of so called “chip breakers” in the form of relatively deep notches cut transversely into the cutting blade in a pattern at spaced intervals, or some similar form of providing an interrupted cutting edge along each blade.

A conventional chipbreaker pattern for a three-fluted end mill design is shown in FIG. 8. As seen, the blade #1 proceeds the blade #2, which in turn proceeds blade #3 for a particular direction of rotation (indicated by the arrow) of the cutting tool. The chipbreaker 30 on the blade #1 is closer to the shank portion 12 than the corresponding chipbreaker 30 on the immediately adjacent following blade #2. In other words, the chipbreaker 30 on the blade #1 is farther from the cutting tip 15 than the corresponding chipbreaker 30 on the immediately adjacent following blade #2. A transition point, P, is located on the front end of each plateau of each chipbreaker 30. The point, P, is a critical part of the geometry and is typically where excessive wear of the cutting tool and tool failure occurs.

As shown in FIG. 9, the conventional chipbreaker pattern produces a chip form 40 having a thickness that is larger toward the cutting end 15 and smaller toward the shank portion 12 of the cutting tool.

In the conventional chipbreaking pattern shown in FIG. 8, the chipbreaker 30 on blade #1 is located such that the chip load per tooth at the point, P, in blade #2 has approximately twice the amount of the programmed chip load per tooth due to the location of the chipbreaker 30 in the proceeding blade #1. This results in accelerated wear and possible premature failure of the cutting tool at the point, P. Therefore, it is desirable to provide a rotary cutting tool that overcomes the shortcomings of conventional rotary cutting tools.

### SUMMARY OF THE INVENTION

In one aspect of the invention, a rotary cutting tool with a longitudinal axis comprises a shank portion; a cutting portion extending from the shank portion to a cutting tip, the cutting portion having a plurality of blades separated by flutes, each of the blades including a leading face, a trailing face, and a land surface extending between the leading face and the trailing face, and a cutting edge at the intersection between the leading face and the land surface; and a plurality of chipbreakers disposed on each blade in a reverse chipbreaker pattern, wherein each chipbreaker on a preceding blade is closer to the cutting tip than a corresponding chipbreaker on an immediately adjacent following blade for a particular direction of rotation of the rotary cutting tool.

In another aspect of the invention, a rotary cutting tool with a longitudinal axis comprises a shank portion; a cutting portion extending from the shank portion to a cutting tip, the cutting portion having a plurality of blades separated by flutes, each of the blades including a leading face, a trailing face, and a land surface extending between the leading face and the trailing face, and a cutting edge at the intersection between the leading face and the land surface; and a plurality of chipbreakers disposed on each blade in a reverse chipbreaker pattern, wherein each chipbreaker on a preceding blade is farther from the shank portion than a corresponding chipbreaker on an immediately adjacent following blade for a particular direction of rotation of the rotary cutting tool.

In yet another aspect of the invention, a rotary cutting tool with a longitudinal axis comprises a shank portion; a cutting portion extending from the shank portion to a cutting tip, the cutting portion having a plurality of blades separated by flutes, each of the blades including a leading face, a trailing face, and a land surface extending between the leading face and the trailing face, and a cutting edge at the intersection between the leading face and the land surface; and a plurality of chipbreakers disposed on each blade in a reverse chipbreaker pattern, wherein each chipbreaker on a preceding blade is closer to the cutting tip than a corresponding chipbreaker on an immediately adjacent following blade such that the chipbreaker on the preceding blade intersects between two chipbreakers on the immediately adjacent following blade for a particular direction of rotation of the rotary cutting tool.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a perspective view of a rotary cutting tool with reversed chipbreaker pattern in accordance with an embodiment of the invention.

FIG. 2 is a perspective end view of the cutting portion of the rotary cutting tool of FIG. 1.

FIG. 3 is an end view of the rotary cutting tool of FIG. 1.

FIG. 4 is an enlarged cross-sectional view of the blade with eccentric radial relief in accordance with the invention.

FIG. 5 is an enlarged view of the chip-breaking feature according to an embodiment of the invention.

FIG. 6 is a schematic view of a three-fluted rotary cutting tool with a chipbreaker pattern in which a chipbreaker of a preceeding blade is located toward a cutting tip with respect to a chipbreaker on an immediately following blade for a particular direction of rotation of the cutting tool.

FIG. 7 is a cross-sectional view of a chip form produced by the chipbreaker pattern of FIG. 6.

FIG. 8 is a schematic view of a three-fluted rotary cutting tool with a conventional chipbreaker pattern.

FIG. 9 is a cross-section view of a chip form produced by the conventional chipbreaker pattern of FIG. 8.

### DETAILED DESCRIPTION OF THE INVENTION

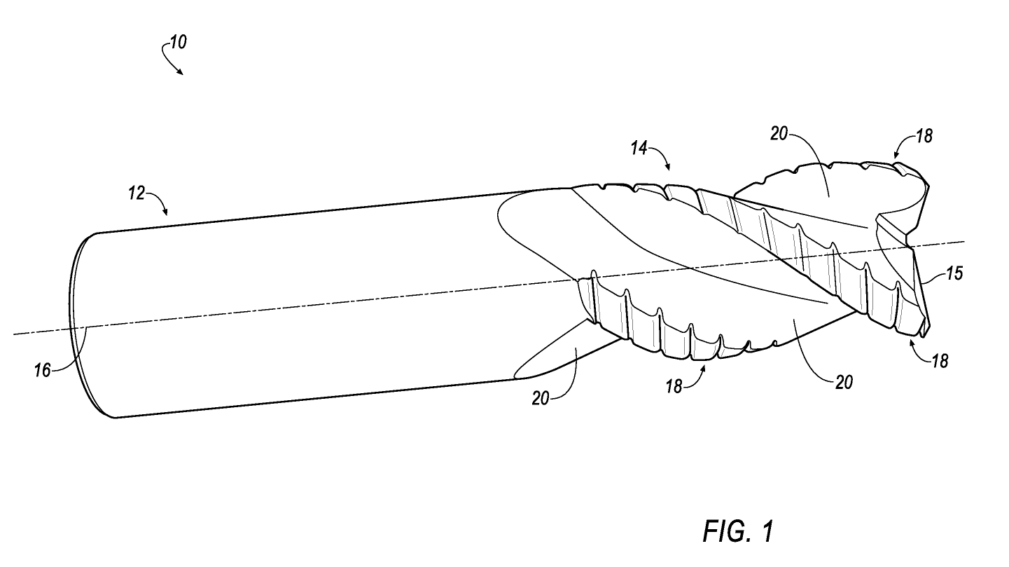

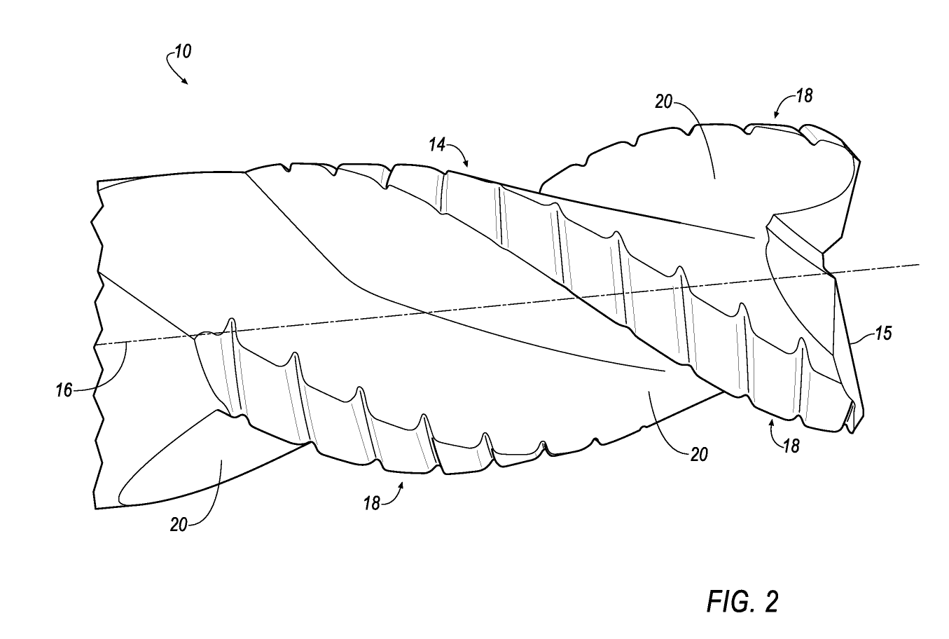

Referring now to FIGS. 1 and 2, a rotary cutting tool 10 is provided that includes a shank portion 12, a cutting portion 14 having a cutting tip 15, and a longitudinal axis 16. The overall shape of the cutting portion 14 may be, but is not limited to, a cylindrical shape or a frustoconical shape. The cutting portion 14 includes a plurality of blades 18 separated by flutes 20 extending the length of the cutting portion 14. In the illustrated embodiment, the rotary cutting tool 10 has a total of three (3) blades 18 and flutes 20 for illustration purposes only. However, it will be appreciated that the invention is not limited by the number of blades and flutes, and that the invention can be practiced with a fewer or a greater number of blades and flutes. For example, the invention can be practiced with four (4) blades and flutes, six (6) blades and flutes, eight (8) blades and flutes, and the like.

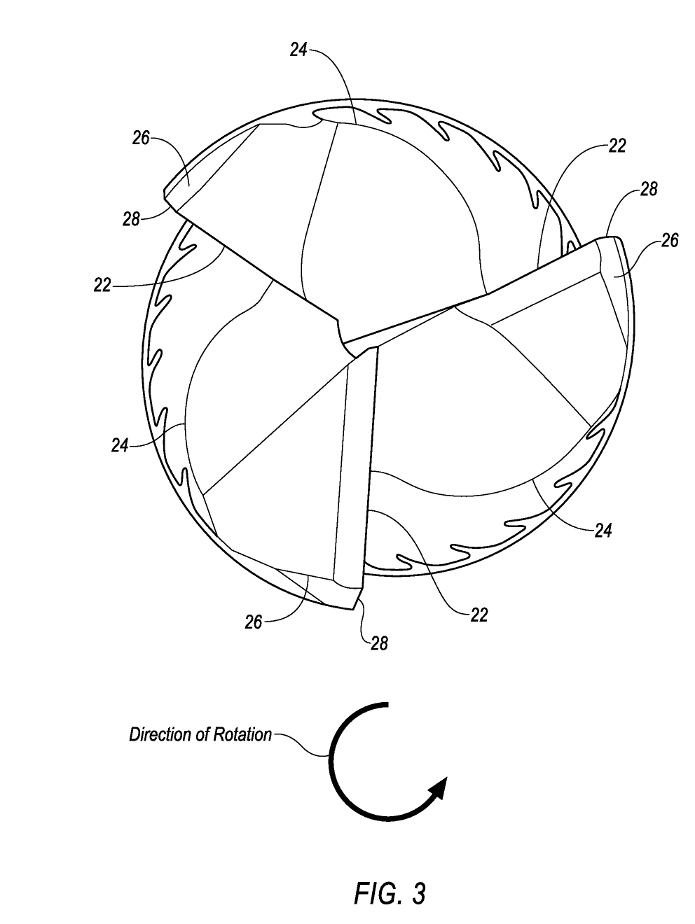

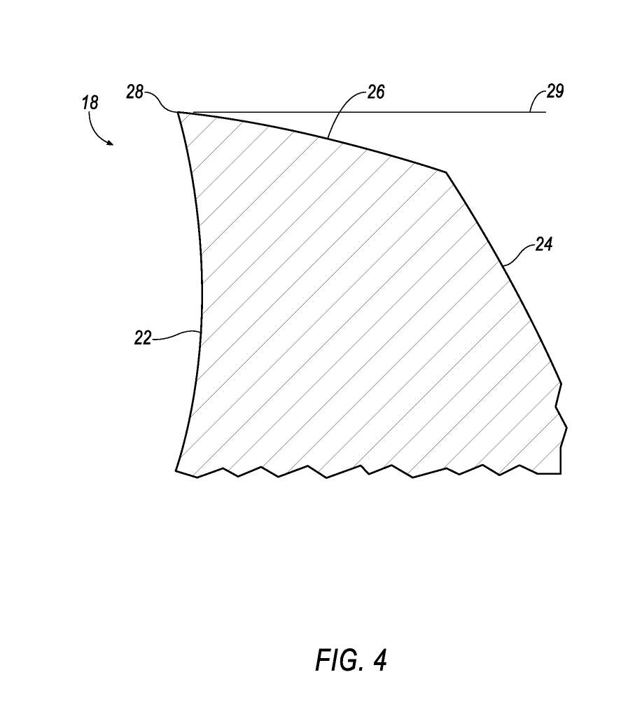

Referring now to FIGS. 3 and 4, each of the blades 18 has a leading face 22, a trailing face 24, and a land surface 26 bridging the leading face 22 and trailing face 24. The intersection between the leading face 22 and the land surface 26 forms a cutting edge 28 for the corresponding blade 18. In some embodiments, the blades 18 and flutes 20 of the cutting portion 14 extend helically within the cutting portion 14 at a helix angle 30 of between about thirty (30) and about forty-five (45) degrees with respect to the longitudinal axis 16. In other embodiments, the blades 18 and flutes 20 are “straight flutes” that extend parallel to the longitudinal axis 16.

As seen in FIG. 4, the land surface 26 of each blade 18 extends arcuately (convex-shaped) within a plane 29 extending perpendicular to the longitudinal axis 16 (sometimes referred to as an “eccentric radial relief”) blending into the trailing face 24.

Referring back to FIGS. 1 and 2, each blade 18 includes a plurality of chip-breaking features 30 in the form of chipbreakers are disposed in the land surface 26 of each blade 18. The chipbreakers 30 disrupt the otherwise continuous cutting edge 28, and thereby create a cutting edge 28 having a varied geometry at the intersection of the leading face 22 and the land surface 26. During operation, the chipbreakers 30 generate a positive pressure relief in the blade 18 in which they are disposed, and thereby significantly enhance the cutting performance of the rotary cutting tool 10.

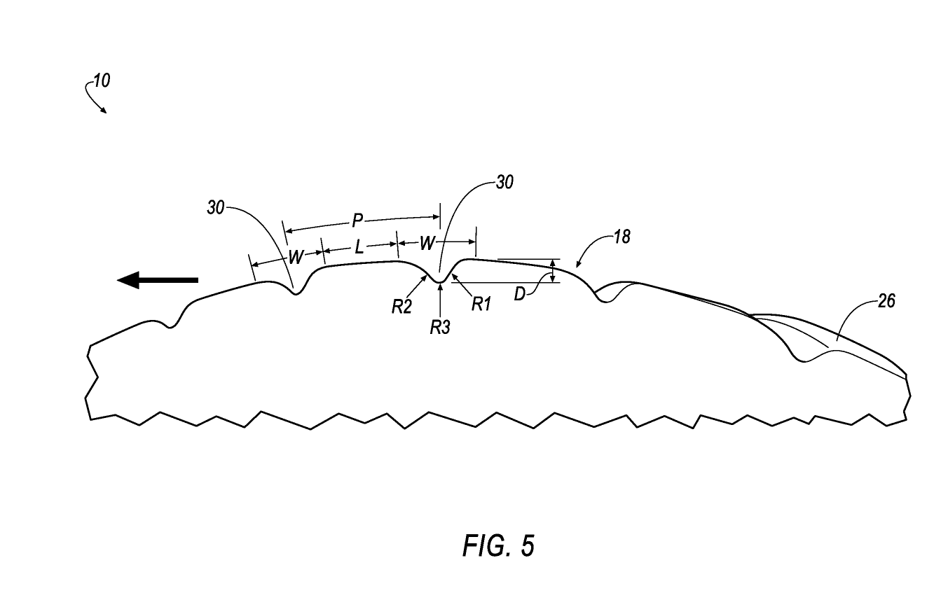

Referring now to FIG. 5, the profile of each chipbreaker 30 includes a small radius portion, R1, a large radius portion, R2, which has a larger radius than the small radius portion, R1, and a joining radius portion, R3, between the small radius portion, R1, and the large radius portion, R2. In the illustrated embodiment, the large radius portion, R2, is closer to the shank portion 12 than the small radius portion, R1 (the direction of the shank portion 12 is indicated by the arrow in FIG. 5). In other words, the small radius portion, R1, is closer to the cutting tip 15 than the larger radius portion, R2. The chip-breaking feature 30 has a width, W, and a depth, D, into the land surface 26. The depth, D, is proportional to the cutting diameter of the rotary cutting tool 10. The pitch, P, is the distance between two immediately adjacent chip-breaking features 30 along the land surface 26 of the blade 18. The length, L, between the two immediately adjacent chipbreakers 30 is the distance between the widths, W, of the chipbreakers 30. In other words, the length, L, defines the land surface 26 in which the chipbreakers 30 is not present on the blade 18.

It will be appreciated that the invention is not limited by the profile of the chipbreaker 30, and the profile of the chipbreaker 30 shown in FIG. 5 is for illustrative purposes only. The chipbreaker 30 may have any desirable profile to will produce an optimum chip form 40. For example, the profile of the chipbreaker 30 may be such that the small radius portion, R1, is closer to the shank portion and the larger radius portion, R2, is closer to the cutting tip 15. In another example, the profile of the chipbreaker 30 may be symmetric in which the small radius portion, R1, and the larger radius portion, R2, have substantially equal radius. In yet another example, the profile of the chipbreaker 30 may be sinusoidal, and the like.

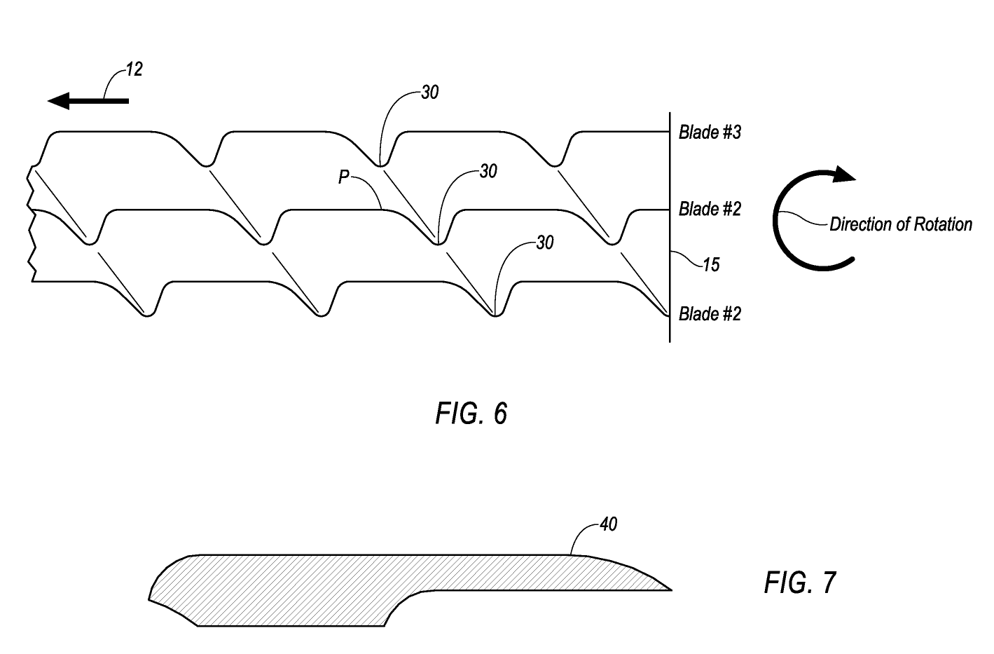

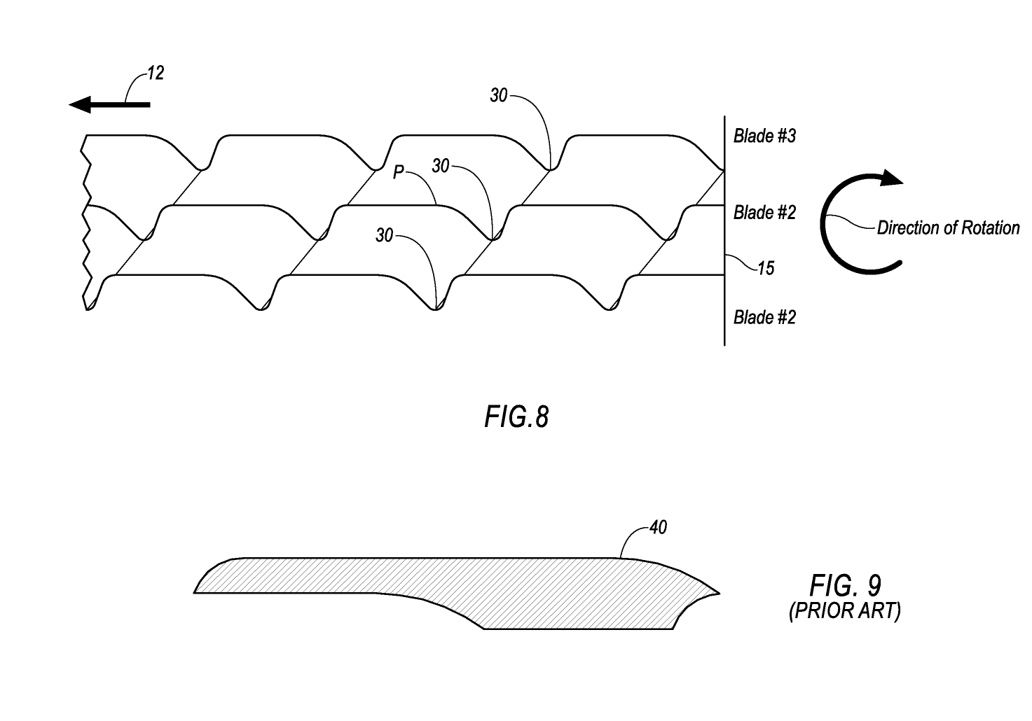

Referring now to FIG. 6, the pattern of the chipbreakers 30 are schematically shown in accordance with an aspect of the invention. As seen, the blade #1 proceeds the blade #2, which in turn proceeds blade #3 for a particular direction of rotation (indicated by the arrow) of the cutting tool during a machining operation. As seen in FIG. 6, the chipbreakers 30 on each blade #1, #2 and #3 are equidistant from each other. In addition, the chipbreaker 30 in blade #1 is located farther from the shank portion 12 (i.e., closer to the cutting tip 15) than the corresponding chipbreaker 30 on the following blade #2, which is a reverse pattern as compared to the conventional chipbreaker pattern in FIG. 8. In other words, the chipbreaker 30 on blade #1 is located closer to the cutting tip 15 than the corresponding chipbreaker 30 on the following blade #2 such that the chipbreaker 30 on the preceding blade #1 intersects between two chipbreakers 30 on the immediately adjacent following blade #2 for a particular direction of rotation of the rotary cutting tool. As a result of the reversed chipbreaking pattern of the invention, the chipbreaker 30 on blade #1 is located such that the chip load per tooth at the transition point, P, on blade #2 is approximately equal to the amount of the programmed chip load per tooth, not approximately twice the amount of the chip load per tooth as in the conventional chipbreaker pattern in FIG. 8.

As shown in FIG. 7, the reversed chipbreaker pattern of the invention produces a chip form 40 having a thickness that is less toward the cutting end 15 and greater toward the shank portion 12 of the tool 10, which is opposite from the conventional chip form 40 shown in FIG. 9.

As described above, the unique, reversed chipbreaker pattern of the invention, reduces the programmed chip load per tooth at the transition point, P, where the blade 18 transitions back into the cut, thereby reducing the failure rate in this area of the rotary cutting tool 10, as compared to the conventional rotary cutting tool. In other words, the reversed chipbreaker pattern of the invention moves the programmed chip load per tooth from the transition point, P, to a point located in the length, L, between adjacent chipbreakers with a substantially straight profile. In one embodiment, the programmed chip load per tooth is located substantially equidistant between adjacent chipbreakers to produce a chip form that is as optimal as possible.

The patents and publications referred to herein are hereby incorporated by reference.

Having described presently preferred embodiments the invention may be otherwise embodied within the scope of the appended claims.

What is claimed is:

1. A rotary cutting tool with a longitudinal axis, comprising:
a shank portion;
a cutting portion extending from the shank portion to a cutting tip, the cutting portion having a plurality of blades separated by flutes, each of the blades including a leading face, a trailing face, and a land surface extending between the leading face and the trailing face, and a cutting edge at the intersection between the leading face and the land surface; and
a plurality of chipbreakers disposed on each blade in a reverse chipbreaker pattern, wherein each chipbreaker on a preceding blade is closer to the cutting tip than a corresponding chipbreaker on an immediately adjacent following blade for a particular direction of rotation of the rotary cutting tool.

2. The rotary cutting tool according to claim 1, wherein at least one chipbreaker is formed by a small radius, a large radius and a joining radius therebetween.

3. The rotary cutting tool according to claim 2, wherein the small radius is closer to the cutting tip than the large radius.

4. A rotary cutting tool with a longitudinal axis, comprising:
a shank portion;
a cutting portion extending from the shank portion to a cutting tip, the cutting portion having a plurality of blades separated by flutes, each of the blades including a leading face, a trailing face, and a land surface extending between the leading face and the trailing face, and a cutting edge at the intersection between the leading face and the land surface; and
a plurality of chipbreakers disposed on each blade in a reverse chipbreaker pattern, wherein each chipbreaker on a preceding blade is farther from the shank portion than a corresponding chipbreaker on an immediately adjacent following blade for a particular direction of rotation of the rotary cutting tool.

5. The rotary cutting tool according to claim 4, wherein each chip-breaking feature is formed by a small radius, a large radius and a joining radius therebetween.

6. The rotary cutting tool according to claim 5, wherein the small radius is closer to the cutting tip than the large radius.

7. A rotary cutting tool with a longitudinal axis, comprising:
a shank portion;
a cutting portion extending from the shank portion to a cutting tip, the cutting portion having a plurality of blades separated by flutes, each of the blades including a leading face, a trailing face, and a land surface extending between the leading face and the trailing face, and a cutting edge at the intersection between the leading face and the land surface; and
a plurality of chipbreakers disposed on each blade in a reverse chipbreaker pattern, wherein each chipbreaker on a preceding blade is closer to the cutting tip than a corresponding chipbreaker on an immediately adjacent following blade such that the chipbreaker on the preceding blade intersects between two chipbreakers on the immediately adjacent following blade for a particular direction of rotation of the rotary cutting tool.

8. The rotary cutting tool according to claim 7, wherein at least one chipbreaker is formed by a small radius, a large radius and a joining radius therebetween.

9. The rotary cutting tool according to claim 8, wherein the small radius is closer to the cutting tip than the large radius.

10. The rotary cutting tool according to claim 7, wherein the plurality of chipbreakers on each blade are equidistant from each other.
